(19) United States
(12) Patent Application Publication
(10) Pub. No.: US 2011/0145138 A1
(43) Pub. Date: Jun. 16, 2011

(54) Browser extension that processes text to facilitate commerce on social media

(76) Inventor: Martin Fitzgerald Bradley, Chicago, IL (US)

(21) Appl. No.: 12/928,588

(22) Filed: Dec. 15, 2010

Related U.S. Application Data
(60) Provisional application No. 61/284,217, filed on Dec. 15, 2009.

(51) Int. Cl. G06Q 40/00

(52) U.S. Cl. 705/39

(57) ABSTRACT

A system (FIG. 1) that extracts designated text from a web page displayed in an internet browser, and uses that extracted text as an identifier to look-up associated payment information which is transmitted to a payment processing service that enables the completion of a payment, thereby allowing ubiquitous text to be used as a substitute for traditional internet payment controls.

### CROSS-REFERENCE TO RELATED APPLICATIONS

This application claims the benefit of provisional patent application No. 61/284,217, filed on Dec. 15, 2009 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to internet browser add-ons or extensions as well as other kinds of client-side software that can be used in conjunction with an internet browser to provide access to internet payment processing services such as those provided by companies like PayPal™ and Amazon Payments™.

2. Prior Art

Social networking websites, blogging websites, and many other kinds of member-community websites are collectively known as, “social media” because they serve as mediums that facilitate social interaction and communication among users, and their massive popularity makes them comparable to traditional communications media such as television, radio, and print media.

Social media gives individuals and small businesses access to a market of hundreds of millions of potential customers. Currently, individuals and small businesses are able to advertise their products on social media; however it is very difficult to actually sell products on many social media websites. This is because many of the most popular social media websites prevent their users from embedding HTML code for “Pay Now” buttons as well as HTML code for hyperlinks that can redirect a user to a payment processing web page. Even though their terms of use policies do not prohibit commercial activity by their members, the technology of many social media websites disables most of the HTML code provided by their members mainly because of the security threat that such code poses.

Many social media sites provide alternative methods to allow their members to engage in commercial activity, but these alternatives tend to be limited to one particular social media site as well as have many other kinds of limitations that the present invention overcomes.

An example of this is Payvment™. Payvment™ is a payment application for use on the social media website Facebook™. Payvment™ gives Facebook™ members an alternative way to engage in commerce since Facebook™ web pages disable HTML-based “Pay Now” buttons. The Payvment™ application allows users to list all of the products they are selling on one page, so a customer can simply select the products they want to purchase. One limitation of the Payvment™ application is that Facebook™ is the only social media website that it can be used on. If a user wants to sell their products on another social media site, they will have to find another solution. Another limitation of the Payvment™ application is that it appears on its own tab or web page on Facebook™, so users must be instructed to navigate to that particular web page or choose, on their own, to select that particular Facebook™ tab. A solution that allows people to sell products from any web page including their most visited web pages would be preferable to being limited to a special tabbed web page that removes the user from the social media landscape and puts them in a purely commercial environment.

Twitter™ is another example of a social media website that does not allow “Pay Now” buttons. The Twitter™ payments alternative is called Twitpay™. Twitpay™ gives Twitter™ users the ability to send money to one another. A limitation of Twitpay™ is that in order to send money the consumer must correctly enter all of the payment information in the form of a Twitter™ message, which requires that the consumer know the Twitter™ user name of the person they are sending money to, the amount to be paid, and other details such as what the payment is for. Another limitation of Twitpay™ is that it doesn't initiate a payment transaction immediately. It only records payment information, and the actual payment transaction is only initiated when the user remembers to go to the internet URL “http://www.twitpay.me”, log in, and select the option to “settle up”. In contrast, a HTML-based “Pay Now” button would initiate a payment and automatically pop-up a new browser window showing the user's shopping cart or payment page where the transaction can be confirmed and completed immediately. The user would then be able to close the pop-up window and continue social networking in their previous browser window.

Requiring users to remember to visit the www.twitpay.me website at their own leisure could hurt a merchant's sales by causing payments to be postponed indefinitely, or even give the user time to change their mind and cancel the promised payment. From a marketing standpoint it is always preferable to have customers complete payment transactions as soon as possible, and as easily as possible much like a “Pay Now” button. Twitpay™ is good for recording debts to be paid at a later date, but it is not good for merchants trying to sell products on Twitter™. Another problem with Twitpay™ is that it relies on human language meanings of words used in the Twitter™ message that creates the promised payment record. It is preferable to have a text-based system of initiating payments that is not limited to human language. This would allow random characters that have no natural meaning to be used to initiate a payment transaction by key-value association, which can minimize the number of characters a payer has to select, type, or otherwise interact with in order to make a payment. It also reduces the amount of information the payer has to have before the payment transaction is initiated, and it makes payment initiation details easier to transmit or broadcast for the merchant. This also provides greater security because some “Pay Now” buttons have their payment initiation details visible in the HTML code, so malicious users could alter the HTML to change the price of a product, or change other details required for payment processing. Associating payment details with text in key-value associations prevents this kind of payment tampering.

Other kinds of prior art include internet browser add-ons or extensions that process text which was either selected by a user or otherwise designated for processing. For clarity, internet browser add-ons (extensions) are features that are added to an internet browser. They usually take the form of an extra menu item added to the browser's main menu or context menu. These menu items when selected, usually execute a client-side script which navigates to or exchanges information with a website to provide the user access to information and services.

U.S. Pat. No. 7,421,432 to Hoelzle, et al. (2008) discloses an internet browser assistant that allows a user to submit selected text to a search engine without leaving their current page. This particular kind of internet search functionality does not provide the kind of service that a merchant can use as an alternative to a “Pay Now” button or otherwise initiate a payment transaction for a particular product or service.

Amazon.com™ is an internet retailer that uses search functionality via browser add-on similar to U.S. Pat. No. 7,421,432. The Amazon.com™ internet browser add-on facilitates searches for products on the Amazon.com™ website no matter what web page a user may be on. For example, a user may be reading an internet article about laptops on a consumer info website. From this website, they can select or highlight the word “laptops”, and then select a browser menu option that allows the browser add-on to execute a search on the Amazon.com website for “laptops”. The result is that a small window pops up inside the user's current browser window that displays laptops that are for sale on Amazon.com™.

Search functionality that produces a list of related information either for a particular website or internet-wide is useful for consumers searching for information or even products to purchase. This type of search functionality is not useful for a particular merchant trying to sell a particular product. A merchant needs internet search functionality that they can control, so they can prompt users to buy a particular product or particular list of products and not present consumers with a list of similar products from various competing merchants.

Another example of prior-art that facilitates internet searches is U.S. Pat. No. 7,233,950 to Smith (2007). Smith's patent discloses a system that associates hypertext links to key phrases stored in a database for the purpose of categorizing and ranking hyperlinks, so the relevance of a hyperlink with respect to a keyword can be determined over time by using feedback from various users. Smith's patent provides no method to associate key phrases with a set of payment initiation variables that can be sent directly to an internet payment processing service for the purpose of facilitating immediate payment transactions.

Internet browser add-ons that process selected text for internet searches and other functions are disclosed by U.S. Pat. No. 7,603,349 to Kraft, et al. (2009), U.S. Pat. No. 7,562,287 to Goldstein, et al. (2009), U.S. Pat. No. 6,725,425 to Rajan, et al. (2004), and U.S. Pat. No. 6,934,750 to Hijikata, et al. (2005). These patents all show the power of internet browser add-ons, but none of these patents aim to provide consumer access to payment processing services.

In October of 2009, PayPal™ introduced a set of developer interfaces that made their payment processing services programmatically accessible by software developers, which helped make the present invention possible. Heretofore, no other payment processing companies offered developers significant programmatic access to payment processing services. Without developer interfaces that provide programmatic access to secure payment processing functionality, it is very difficult to implement a solution such as that being proposed for this patent. This may explain why the prior art does not disclose a payment solution that is closely related to the present invention.

### OBJECTS AND ADVANTAGES

Accordingly, several objects and advantages of my invention are:

(a) to provide a viable alternative to “Pay Now” buttons and hyperlinks in order to facilitate immediate payment processing on social media and other websites that do not allow HTML code embedding;

(b) to allow merchants and consumers to exploit the ubiquity of standard text in order to buy or sell products in a wide-variety of social media contexts that use standard text; and

(c) to introduce a new way to use internet browser add-on/extension capabilities in order to make secure payment processing services available from any web page that a consumer is browsing.

Other objects and advantages include the empowerment of individuals and very small businesses to creatively use the various contexts of social media to reach the enormous market of over 500 million social media users. The various contexts of social media include picture captions, video descriptions, comment and message boards, private message files, instant message exchange, and many other ways social media enables people to communicate with each other. All of these social contexts involve standard text. By using standard text as a medium to initiate secure payment processing, this invention allows commercial marketing to blend in naturally with the social media landscape. Now social media users can use text to both communicate and exchange money. This opens up many new opportunities for social marketing on the most popular social media websites.

This invention enables social marketers to more easily exploit the popularity of a particular social media page or social media user; it allows people to make immediate purchase decisions without being removed from the social media landscape; it allows marketers to make better use of social rewards, acknowledgements, and other kinds of social influences for financial gain; it allows marketers to do a better job of exploiting the interconnectedness and “word-of-mouth” power of social networks for marketing purposes; and it facilitates new and creative social-commercial interactions such as social fund-raising games, friendly exchanges of money, and social-commercial partnerships.

Further objects and advantages of my invention will become apparent from a consideration of the drawings and ensuing description.

### SUMMARY

In accordance with the present invention a system that extracts designated text from a web page displayed in an interne browser, and uses that extracted text as an identifier to look-up associated payment information which is transmitted to a payment processing service that enables the completion of a payment.

### DRAWING FIGURES

FIG. 1 shows the lines of communication between the major components of the present invention.

FIG. 1A shows the column headers for the table in the database that enables key-value association functionality.

FIG. 1B shows the software process that is implemented by the Key-Value Look-Up web page.

FIG. 1C shows the user interface of the Key-Value Manager web page.

### DESCRIPTION

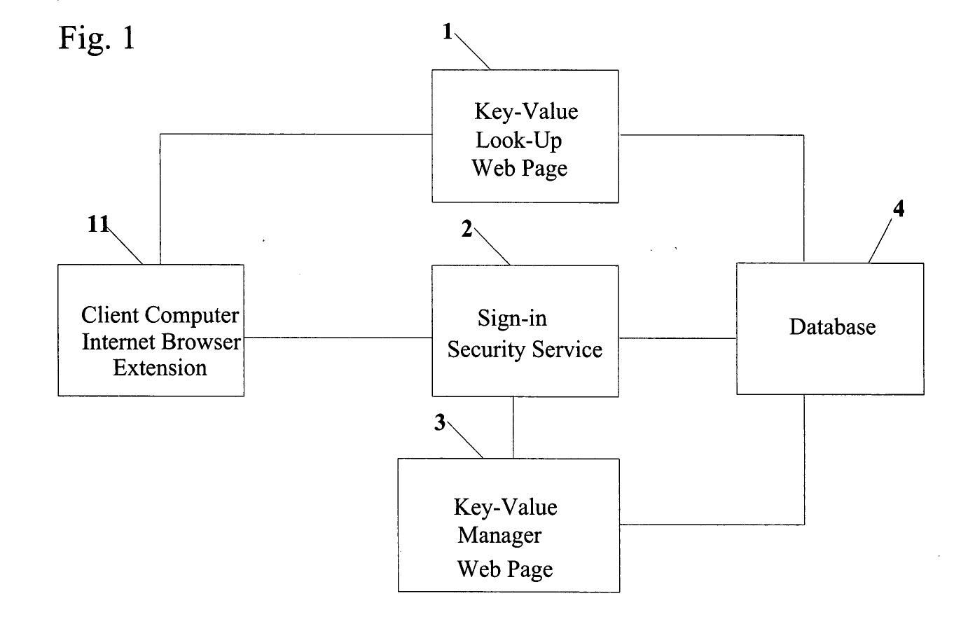

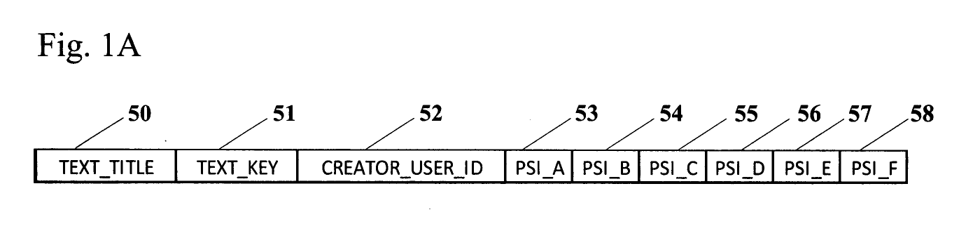

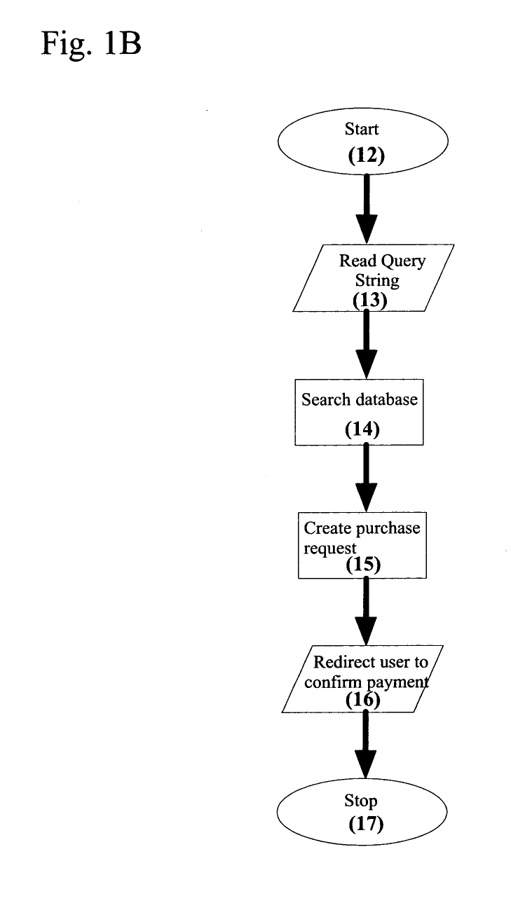

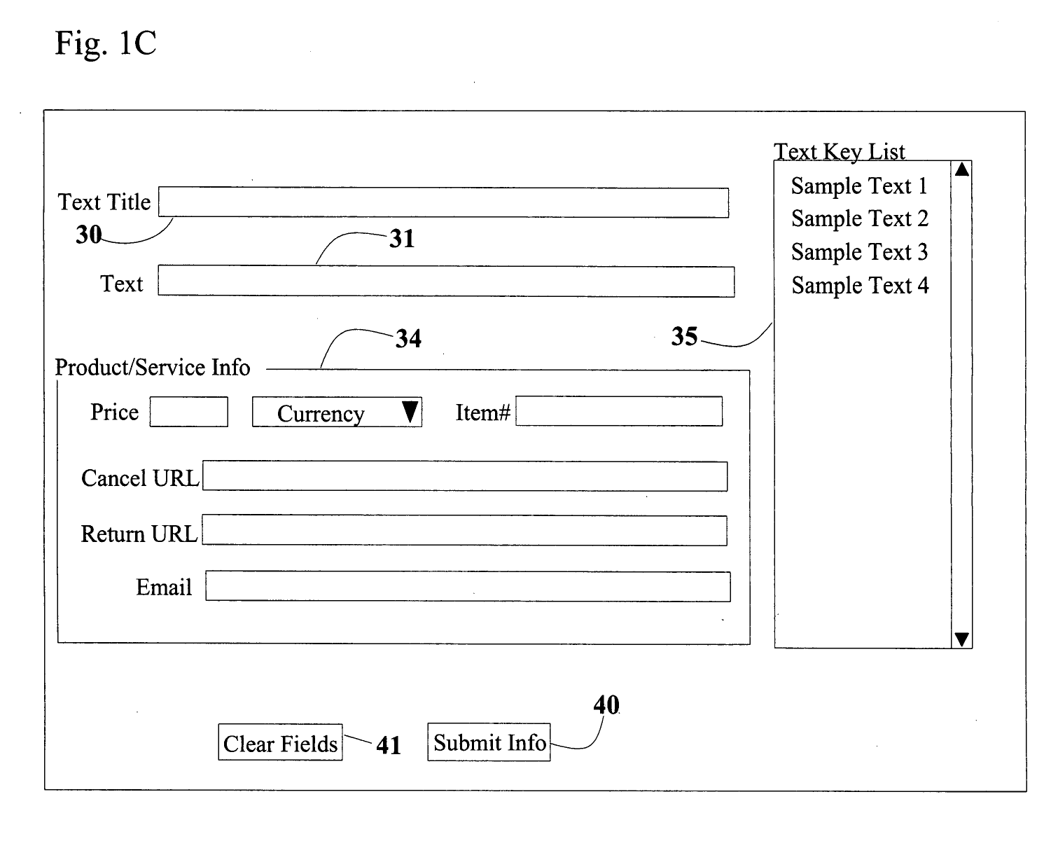

The present invention is comprised of two major components: client-side software, and server-side software. These two components communicate with each other by exchanging information across a computer network in various ways depending on the invention's embodiment. A preferred embodiment, as shown in FIG. 1, allows a client computer 11 to communicate with server-side software components 1, 2, 3, and 4 using internet web pages that are accessed via an internet browser. To achieve the objects and advantages of the present invention, the client computer 11 must ultimately send data to and retrieve data from a relational database 4. The organization of the database 4 and the methods used to access and modify it are central to enabling the key-value association functions of the server-side software.

FIG. 1A shows the column headers of the data table in the database 4 (FIG. 1) that will be described in detail for this patent. The purpose of the data table is to associate a string of text characters with a set of payment initiation details that specify a particular merchant's account and a particular product's price information and other details needed to initiate and complete a payment. This allows text to be used as a key to look-up a specific set of values that can enable a payment for a particular product or service. In the preferred embodiment, this is achieved using the secure payment service application interfaces provided by PayPal™

The data table in FIG. 1A has column TEXT_KEY 51, which cannot hold null values, and treats the data that it accepts as text. Text, in this case, refers to what is known in computer science as the data type “String”. An instance of a String is made up of zero or more characters (usually ASCII or Unicode), and is primarily used for display purposes. TEXT_KEY 51 stores a unique string of characters in every row, so those character strings can be used as keys to return the other data values stored in different columns of the same row. This column holds variable length character strings of no more than 45 characters.

The data table also has column TEXT_TITLE 50, which stores a title for each row. This column 50 also recognizes its data as text, but it can accept null values. This column 50 accepts variable length character strings no longer than 50 characters. The purpose of this column 50 is to give the user a way to identify and distinguish each of the key-value associations they have created.

The CREATOR_USER_ID column 52 stores integer values, which are used to identify the particular user that created a key-value association. This column 52 cannot accept null values because everyone creating a row in the data table must be identifiable, so they can retrieve their own data from the table. This column 52 holds integer values large enough to identify at least one-billion individual users.

Six of the columns in the data table are reserved for product/service information that is required to initiate a payment transaction using PayPal's Adaptive Payments™ application interface. The PSI_A column 53 stores text data of variable length and no more than 50 characters, and does not accept null values. This column 53 stores the price of the product or service being sold. This is the amount minus commissions that will be credited to the seller's PayPal™ business account.

The PSI_B 54 and PSI_C 55 columns store data as text of variable length. These columns 54-55 do not accept null values and they each hold a maximum of 1000 characters. PSI_B 54 stores the URL of the web page that a user should be navigated to after they have verified and completed a purchase transaction at the PayPal™ website. PSI_C 55 stores the URL of the web page a user should be navigated to after they have reviewed an initiated purchase transaction and cancelled it before it was completed.

The PSI_D column 56 stores text data of exactly three characters. This column does not accept null values. PSI_D 56 stores currency code data that indicates the kind of currency that should be accepted to complete a purchase.

The PSI_E column 57 stores text data of variable length and no more than 256 characters. PSI_E 57 stores the seller's email address, which is used by PayPal™ to identify a seller's account where the money will be deposited. This column 57 does not accept null values.

The PSI_F column 58 stores text data of variable length, and no more than 50 characters. This column can store a null value. This column holds product identification information so the merchant knows what product or service to deliver.

FIG. 1 shows that the database 4 is accessed and modified by a client computer 11 via web pages and web services. The Key-Value Look-Up web page 1 is the server-side component that allows users to return values from text-keys. Text-keys, for this patent, refer to character strings of zero or more characters that are either stored in the TEXT_KEY column 51 (FIG. 1A) or extracted from a browser and looked-up or compared to values in the TEXT_KEY column 51 for the purpose of returning the specific payment initiation details that are associated with it.

The Key-Value Look-Up web page 1 (FIG. 1) has no user interface, and the web page itself never actually loads in the client's interne browser. Instead a software process is initiated in the web page's pre-load event. This software process reads the text-key that is attached to the web page's URL and processes it, so a value can be returned from the database 4, and then the user is redirected to a payment confirmation web page.

FIG. 1C shows the user interface of the Key-Value Manager web page 3 (FIG. 1). This web page contains text and list controls 30-41 that allow a user to view and enter text content in order to create, review, and modify text-keys and their associated values. The Key-Value Manager web page 3 achieves this via its software processes that provide read and write access to the database 4.

FIG. 1 shows that the Key-Value Manager web page 3 is access-protected via the Sign-in Security Service 2. The Sign-in Security Service 2 is a common security system used by most websites that hosts multiple user accounts, and need to provide specific information that is pertinent only to a specific user. It requires a user name and a password in order to identify a specific user. Then it grants that user access to the Key-Value Manager web page 3, but it only allows the user to view and modify text-keys and values that they have created. A user cannot view or modify text-keys and values created by other users without the sign-in info of those other users. The Sign-in Security Service 2 is able to access the database 4, which contains user names and passwords for each user account. It also enables the creation of new user accounts. It generates a user I.D. number for each new user, and associates that number with the user's sign-in info. So a signed-in user can have access to database information associated with their user I.D. number.

The Client Computer 11 in FIG. 1 does not represent a particular computer. It represents any client computer that has access to the internet, and is able to access web pages 1 and 3 via an internet browser. The Client Computer 11 actually represents many computers of all kinds—desktops, laptops, netbooks, PDAs, smartphones, and any other kind of computer with the ability to access the internet in order to retrieve web pages or retrieve other kinds of information from a server.

In the preferred embodiment, the internet browser extension is a JavaScript™ code file that can be executed from the internet browser's user interface. The preferred embodiment extends the browser's context menu for user-selected text by adding a menu item for looking up text-keys. That menu item executes the JavaScript™ code which retrieves the selected text from the web page and makes it a query string concatenated to the URL of the Key-Value Look-Up web page 1. It then opens a new browser window and navigates it to the URL of the Key-Value Look-Up web page 1. In the preferred embodiment, Microsoft's™ Internet Explorer™ browser is extended using registry entries to the Windows™ operating system's registry. The registry entries modify the browser's user interface by adding an option to the text-selection context menu and they store the location of the JavaScript™ code to be executed when that option is selected.

### Operation

The operation of the client-side software begins with a user downloading the client-side software installer, which is a stand-alone application that can be made available or downloaded from any website. When this application is downloaded and executed on a computer with the Windows™ operating system, it connects to the Sign-in Security Service 2 via web service. It then displays a window that prompts the user to create an account by supplying a user name and a password. Once the user creates a user account, a user I.D. number is generated and stored in the database 4 along with the user name and password. The final installation step is the actual extension of the Internet Explorer™ browser. The installer stores a JavaScript™ code file on the computer and modifies the operating system's registry, so Internet Explorer's™ context menu has an item added to handle selected text, and to ensure that the new menu item executes the proper JavaScript™ code file.

Once the client-side software is installed, a user viewing web pages or files in Internet Explorer™ can select text and right-click it to open the browser's context menu and then select the item from the menu which executes the JavaScript™ code.

When the JavaScript™ code is executed it does three things. First it extracts the text that was selected by the user in the web page. Secondly, it adds a query string to the URL of the Key-Value Look-Up web page 1. Specifically, it takes the text that it extracted and concatenates it to the URL of the Key-Value Look-Up web page 1. This concatenation is preceded by a “?” which allows it to be recognized as a query string by the server that receives the URL request. Thirdly, the JavaScript™ code opens a new instance of Internet Explorer™ and navigates the browser to the URL of the Key-Value Look-Up web page 1 with the attached query string.

The Key-Value Look-Up web page 1 allows text to be used as a key which returns values that can be used to initiate a payment transaction through PayPal™. First, the Key-Value Look-Up web page 1 receives text via query string. Then it uses this text as a key to return values from the database 4. The actual software process that accomplishes this is depicted in FIG. 1B.

The software process starts 12 after the JavaScript™ Code File navigates the client computer's internet browser 11 to the URL of the Key-Value Look-Up web page 1 concatenated with a query string.

The query string contains the text-key that the user selected from a web page. In step 13 of the software process, the text-key contained in the query string is copied and held in memory by a variable on the server.

The software process proceeds to step 14, which searches the data table FIG. 1A rows in column 51 until it finds the row that matches the text-key exactly. Once that row is found, it then retrieves all of the purchase initiation information from the columns 53-58 of that particular row and holds that data in memory using variables.

In step 15, the purchase initiation information retrieved from the data table is used to create a purchase request using PayPal Adaptive Payments™ application interfaces. Those interfaces can be found at the PayPal™ website along with code samples. In step 16, the user's interne browser is navigated to the URL of the PayPal™ payments confirmation page where the user can confirm and complete the purchase initiated in step 15. This is the point where the software process ends 17.

To create and modify text-keys, a user must sign-in using their user name and password via the Security Sign-in Service 2 (FIG. 1). Once signed-in, they are able to access the Key-Value Manager web page 3. The user interface for the Key-Value Manager web page 3 is shown in FIG. 1C. When the Key-Value Manager web page 3 loads in the client computer's browser 11, the Text Key List control 35 is automatically populated with a list of text-keys created by the current user. It retrieves this list by matching the current user's user I.D. number with all text-keys that share a row with a matching user I.D. in the data table column CREATOR_USER_ID 52 (FIG. 1B).

When a text-key is clicked or selected in the Text Key List control 35 (FIG. 1C), the Text Title control 30 displays the user-created title for the selected text-key, which may serve as a reminder of the text-key's function. Control 30 also turns yellow to indicate that its contents are editable. Text control 31 displays the full text of the text-key, and it appears yellow to indicate that its contents are editable. Each of the Product/Service Info controls 34 displays information about the payment details associated with a text-key including price, currency type, item number, and the email of the seller which is used by PayPal™ to credit the seller's account. This control 34 also displays the cancel and return URL's related to the PayPal™ payment flow. All of the Product/Service Info controls 34 appear yellow indicating that they are editable.

In order to create a new text-key, a user simply clicks the Clear Fields 41 button, and enters the appropriate information to the appropriate text and list controls. The user then clicks the Submit Info 40 button, and a unique text-key is generated and displayed by Text-Key List 35.

Once a merchant has created text-keys for all of the products and services they want to sell, those text-keys can be placed in many different social media contexts that display text. Text-keys can be in the caption of a picture, in the description of a video, in a comment on a message board, in a private message or a broadcast message. Since text is so ubiquitous and the primary form of communication on the internet, there is virtually no limit to how text-keys can be used to sell products on social media or the entire internet. Consumers who have the browser extension can use these text-keys to make an immediate purchase.

### CONCLUSION, RAMIFICATIONS, AND SCOPE

The present invention enables the use of text as a substitute for hyperlinks and other kinds of web page embedded controls that enable access to payment processing services on the internet. This kind of substitution is desirable on social media websites, such as Facebook™ or YouTube™ because hyperlinks and web page embedded controls are often not an option or not easy to use on such websites. However, the present invention should not be seen as limited to internet use. The present invention can be adapted for use in any situation where information is being exchanged over a computer network, and user-created text-keys are needed to substitute for hyperlinks or more advanced controls that facilitate commercial activity via an information exchange between a client computer and a server. That is, the size of the computer network may vary. The present invention can be implemented in local, regional or campus-sized networks whose users engage in social and commercial activity. The network does not have to be a part of or be as large as the internet.

The type of network may also vary. The preferred embodiment illustrates a network of client computers that send requests to a central server, but in a peer-to-peer network, the client computers may also act as servers. Instead of having key-value associations stored on a single server, they may be stored on many servers. In that case, many computers in the network serve a dual role as both server and client. They may provide information to meet their own requests, or send information in response to requests from other client computers in the network, or send their own requests to other dual-role computers in the network.

The description of the preferred embodiment illustrates one specific way to extend one specific type of internet browser, but there are a many ways to extend the Internet Explorer™ browser. And many other internet browsers can have the same functionality added using a myriad of programming options. Many of these options may include the use of a JavaScript™ file, but many may not. For example, the C++ language can be used to create a Microsoft™ ATL™ file that can perform similar functions as JavaScript™. In Internet Explorer 8™, an Accelerator™ offers a way to add functionality to a browser by connecting to an external XML service which negates the need for a client-side script of any kind.

For this patent, internet browser extensions include independent software applications that are not directly connected to a browser, but can still be used in conjunction with a browser to extract text-keys from a document displayed or otherwise present in the browser. Once text-keys are received by an independent software application, it can connect to a web service to retrieve, process, and display payment services without the use of a browser. An independent software application may be activated in various ways, such as an icon that is strategically positioned on a computer display such that it is accessible to a user at all times, or made available by keyboard keystrokes or speech recognition. Easy activation in various ways is especially desirable if the client computer is a very small mobile device or otherwise has a limited user interface.

Text-keys themselves are not limited to being selected by a cursor-drag function and clicked by a user with a common graphical user interface (GUI) computer. Text-keys may be viewed in a browser display and entered manually with keyboard keystrokes, a keyboard-based cursor-drag function, keyboard or GUI-based copy/paste functions, speech recognition, or text can be delimited or designated in a way that makes it distinguishable from other text in a document, so a computer can automatically extract it and submit it to a process that provides access to payment processing services. There are many ways to allow user-selected or designated text to be submitted to a computer process that provides access to payment processing services.

The creation and use of text-based key-value associations can also vary. A unique text-key can be generated from a computer process, or the user may have the option of creating an available text-key. Text-keys may be stored in various ways that differ from the preferred embodiment because a database is not the only way to store key-value associations. And text-keys may not be intrinsically unique when compared to other text-keys, they may be contextually unique. Meaning a text-key may only be unique when it is used in a specific context. For example, a text-key may not be unique in a data table column, but when considered in combination with another column may be used to return a unique row from a data table. Text-keys are also not limited to the computer data type “String”. Text characters are used by computers to represent other data types such as numbers, dates, and times, so text-keys can take the form of any data type that can be represented with text characters.

The PayPal™ API that is described in the preferred embodiment has many more functions than are described in this patent. Therefore, various embodiments of this invention may implement a myriad of commercial functions that are provided by PayPal™. This patent describes the most basic money exchanging PayPal™ API that is needed to facilitate the most basic commercial activity. The other APIs are secondary. For example, PayPal™ offers functionality which enables users to easily form profit-sharing partnerships. This API is not useful without the basic ability to implement money exchanges. That is to say, many more features can be added to the present invention using PayPal™ APIs. Furthermore, PayPal APIs are not the only way that the payment processing functionality of this invention can be implemented. At its core, the present invention associates text-keys with any kind of money transfer details that can be used to initiate a money transfer using any kind of money transfer service provided by any source.

The uniqueness of this invention may be embodied in various ways. So the specific embodiment shown in the drawings and described here in detail should be considered an exemplification of the principles of the invention and should not limit the invention to the embodiment illustrated.

I claim:

1. A system for using text to facilitate the transfer of money over a computer network, the system comprising:
(a) a text key creation means for creating and storing an association between text and money transfer details such that said text can be used as a key to look up said money transfer details;
(b) a text key look up means for looking up said text and returning said money transfer details that are associated with it;
(c) a money transfer means capable of receiving money transfer details returned from said text key look up means and executing a money transfer over a computer network using said money transfer details;
(d) a document manager means for placing said text in a document, and making said document retrievable by computers in the network;
(e) a browser means for displaying documents made retrievable by computers that are a part of said computer network;
(f) a browser extension comprising:
(1) an input means for receiving said text from said document displayed in said browser means;
(2) a communication means for sending said text to said text key look up means.

2. A method for using text to facilitate money transfer over a computer network, comprising:
(a) associating text with money transfer details;
(b) processing said text to provide access to money transfer services that utilize said money transfer details to make a money transfer.
